(19) United States
(12) Patent Application Publication
(10) Pub. No.: US 2004/0093679 A1
(43) Pub. Date: May 20, 2004

(54) Scrubbing sponge with indicia and method of making same

(76) Inventor: Jay Kukoff, Springfield, NJ (US)

Correspondence Address: Kirschstein, Ottinger,, Israel & Schiffmiller, P.C., 489 Fifth Avenue, New York, NY, 10017-6105, US

(21) Appl. No.: 10/295,146

(22) Filed: Nov. 15, 2002

(51) Int. Cl. A47L 13/16; B32B 5/30; B32B 7/14

(52) U.S. Cl. 15/118; 15/244.4; 156/291; 156/297

(57) ABSTRACT

A scrubbing sponge is made with indicia by applying a light-transmissive adhesive in a pattern on the sponge, and adhering a plurality of discrete, shaped pellets of light-transmissive synthetic plastic material on the patterned adhesive. The indicia is visible through the pellets and the adhesive and serves as a promotional aid.

### BACKGROUND OF THE INVENTION

1. Field of the Invention

This invention generally relates to artificial sponges for cleaning purposes and, more particularly, to making such sponges with promotional indicia thereon.

2. Description of the Related Art

It is known from U.S. Pat. No. 4,969,226 to make a sponge having multiple projections molded of polyurethane for increased scrubbing power, and from U.S. Pat. No. 3,857,133 to provide a sponge having abrasive foam pieces thermally bonded thereon. Although generally satisfactory for their intended purpose, the known cleaning sponges are relatively expensive to fabricate and, in any event, do not bear any indicia that, for example, identifies or promotes an organization or product. Such sponges are typically sold individually or in sets that are held together by a wrapping bearing indicia. However, once the wrapping is removed and discarded, there are no means by which a consumer can know by inspecting the sponge any information about the sponge, because the sponge is plain and bare.

It is also known from U.S. Pat. No. 3,377,184 to apply a tacky adhesive, preferably a polyvinylchloride plastisol, to a base fabric material in a desired pattern, and thereupon to apply or flock a plurality of extruded, cut particles of synthetic plastic material onto the tacky adhesive. The excess particles are then removed. The adhesive is cured by being heated. The plastic particles are thus fixedly set on the fabric material. The adhesive may be applied thicker or thinner depending on its proposed use; see, for example, U.S. Pat. No. 3,582,440.

### SUMMARY OF THE INVENTION

### Objects of the Invention

It is a general object of this invention to provide a novel scrubbing sponge and a method of making the same with indicia.

Still another object of this invention is to make a sponge that can readily serve as a promotional aid.

An additional object of this invention is to provide a pelletized sponge from which the pellets will not fall off, especially during cleaning.

Another object of this invention is to provide a decorative sponge that promotes a product or organization.

### Features of the invention

In keeping with these objects and others which will become apparent hereinafter, one feature of this invention resides, briefly stated, in an indicia-bearing cleaning device and a method of making the same. The method comprises the step of applying a light-transmissive adhesive in a pattern either directly on an outer surface of a sponge, or on an outer surface of a material layer that is adhered to the outer surface of the sponge.

The method further includes the step of adhering a plurality of discrete pellets of light-transmissive synthetic plastic material to the outer surface of the sponge or material layer by contacting lower surfaces of the pellets on the adhesive. Upper surfaces of the pellets above the outer surface contact a surface to be cleaned during use.

Each pellet is preferably shaped as an ovoid or a sphere and has a major dimension or diameter in a range from 1/32 to 1/16 of an inch.

In the preferred embodiment, the pellets are gathered in groups that are spaced apart. Each group has a plurality of pellets in a range of two to ten in number.

Indicia is provided at the outer surface of the sponge or material layer. Preferably, the indicia promotes a product or an organization. The indicia can also be any graphical image or textual information. The indicia is preferably permanently printed on the outer surface of the sponge, or on the outer surface of the material layer. The indicia is visible through the adhesive and the pellets and does not dissolve in water.

Thus, in accordance with this invention, the sponge is not bare and plain, but instead serves as a promotional aid to advertise a product or organization to a user every time the user uses the sponge. The resulting sponge not only has a decorative appearance, but also is an effective cleaner. The pellets will not become dislodged from the sponge during cleaning.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a cleaning device in accordance with this invention; and

FIG. 2 is an enlarged, broken-away, sectional view taken on line 2-2 of FIG. 1.

### DETAILED DESCRIPTION OF THE PREFERRED EMBODIMENTS

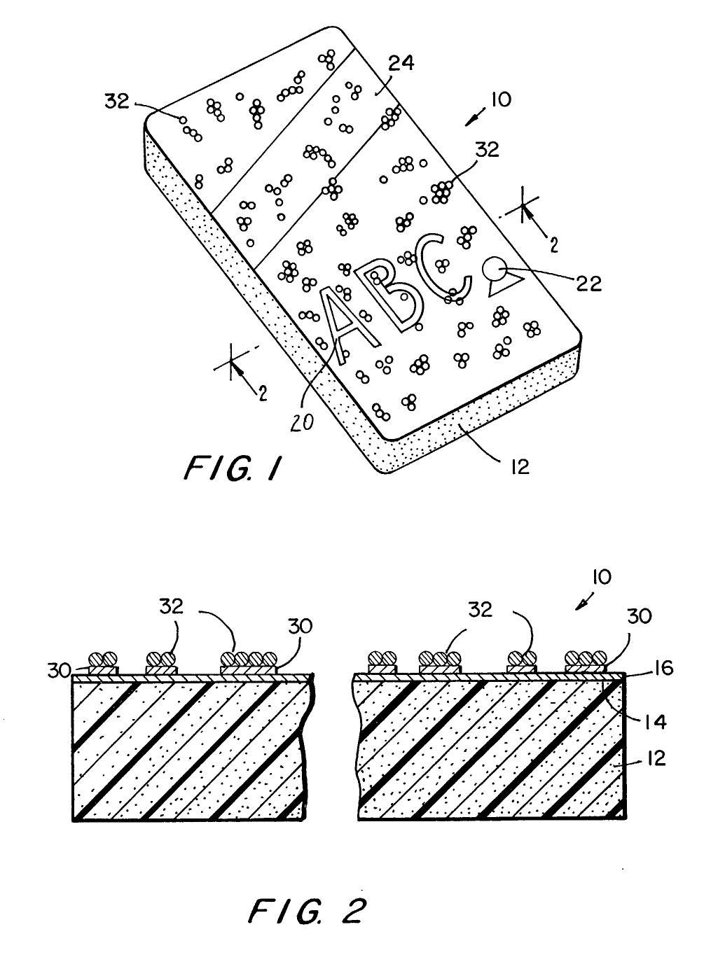

Referring now to the drawings, reference numeral 10 in FIG. 1 shows a cleaning device manufactured in accordance with this invention. The device 10 includes a generally rectangular sponge 12 having a generally planar, outer surface 14. A material layer 16 is adhered or fused on the outer surface 14. The sponge is artificial and is generally soft and pliable when wet. The sponge itself is conventional and has a uniform textured surface and may comprise open or closed foam cells.

A layer of a light-transmissive adhesive 30 is applied over the layer 16 in any desired pattern or design. Preferably, the adhesive is a curable plastisol which is applied in a liquid state to the layer 16, either by hand or through a sieve, stencil, screen or analogous pattern-forming device to obtain the desired pattern. The wet adhesive 30 penetrates slightly among interstices of the layer 16. The layer 16 is preferably a fabric of sheet material.

Basically, the plastisols are composed of vinyl chloride resin particles dispersed in a plasticizer to which may be added stabilizers, pigments, gelling agents, mineral spirits (for thinning) and similar modifying additives. The formulation of plastisols usable with the present invention is quite wide. For example, based upon 100 parts by weight of vinyl chloride resin, the amount of plasticizer may vary from 50 parts to 200 parts and the amount of pigment, stabilizers and/or other modifying components may vary between 0 and 10 parts.

Typical examples of plastisols which may be used with the present invention are as follows:

Pounds

(1)

| | |
|---|---|
| Polyvinylchloride resin (QYNV) | 100 |
| Diisooctylphthalate | 80 |
| Dibutyl tin maleate | 1 |

(2)

| | |
|---|---|
| Polyvinylchloride resin (Geon 121) | 100 |
| Dioctylphthalate | 80 |
| Barium-cadmium laurate | 1 |

(3)

| | |
|---|---|
| Polyvinylchloride resin (Exon 654) | 100 |
| Tri cresyl phosphate | 80 |
| Tri basic lead stearate | 2 |

Plastisols made according to the above formulations have the characteristics of pliability, flexibility and softness rather than the stiffness and hardness of other types of adhesives. They may be readily cut or sewn and then can withstand repeated washing or dry cleaning and have good, long-lasting wearing characteristics. If desired, these plastisols may contain pigmentation and may be thinned by mineral spirits. In this manner, the polyvinylchloride may be thinned to be free flowing for a flat appearance, or thickened so as to be viscous to give a high raised appearance where desired. The plastisol is light-transmissive.

In the preferred embodiment, the plastisol is applied by being pressed through openings in a silk screen. The plastisol flows freely through the screen openings and will not clog them, thereby assuring that the screen can be re-used. The openings may have extremely fine detail and, hence, the adhesive pattern can be likewise very detailed.

Next, a plurality of discrete pellets 32 constituted of light-transmissive synthetic plastic material is applied to the wet adhesive before the adhesive has dried or is cured. The plastic pellets are three-dimensional rounded spherical or ovoidal shapes and, in a preferred embodiment, each measures in a range of 30 to 80 mils along each dimension.

In the preferred embodiment, the pellets are made of a plastic from the polyvinyl group, preferably polyvinylchloride. Such pellets are readily held by the plastisol adhesive. Additional suitable plastics may be selected for the pellets from those plastic compounds having polymers obtained from polymerization of unsaturated compounds. The pellets are durable enough to maintain their shape during use and can be dry cleaned or washed at normal temperatures. The pellets are relatively light so that a large number may be placed on the layer 16 without unduly weighing it down. Any combination of shapes and/or sizes of plastic pellets may be utilized as desired. The plastic pellets, like the plastisol, are light-transmissive.

The pellets are flocked onto the adhesive-coated pattern on the layer by hand or by using a suitable sieve. The plastic pellets stick to the wet, tacky, adhesive-coated portions, and a pattern of plastic pellets corresponding to the pattern of the adhesive is laid down on the layer 16.

In accordance with this invention, the pellets are arranged and gathered in groups or clusters spaced apart from one another. Each group comprises at least two, and preferably from three to ten, mutually contacting pellets clustered together. These groups are placed across the entire upper surface of the layer 16. The pellets are of different, random sizes and, hence, the upper rounded surfaces of the pellets contact the surface to be cleaned at different elevations for a vigorous scrubbing action.

After the plastic pellets are applied to the layer 16, the excess pellets which did not initially adhere to the layer are removed, for example, by shaking the sponge or by using air or gas to blow off the excess pellets. Preferably, a vacuum cleaner or analogous suction device picks up the excess pellets. As shown in FIG. 2, after the excess pellets are removed, the remaining pellets have lower rounded portions which are in contact with the plastisol and which are adhered to the layer. Upper rounded portions of the pellets engage the surface to be cleaned during use.

In order to firmly fix the pellets to the layer, the plastisol is heated to its curing point, i.e., the temperature at which the polyvinylchloride particles in the plastisol solidify. This is accomplished by placing the sponge on a heated plate, or by placing it in an oven, or by using infrared heating lamps, or by using any other suitable heating means. All of the plastisols described above have a heat curing temperature in the range of between 300° F. to about 400° F., and all will adhere firmly to a fabric or other porous material. The pellets are reliably anchored in place and do not become detached from the sponge during use.

In accordance with this invention, indicia is provided on the sponge and is visible through the light-transmissive adhesive and pellets. The indicia may include text 20, artwork 22, a graphic element 24 and, in short, any information to be conveyed to a user. Preferably, the indicia is promotional and used to advertise a product or organization.

The indicia is preferably permanently printed on the sponge or layer 16, and advantageously in color against a contrasting colored background. The indicia is applied with a permanent ink or paint that is non-soluble in water so that the indicia remains in place during cleaning which, of course, is performed with the sponge wet and often in the presence of soaps, detergents, and cleaning agents.

It will be understood that each of the elements described above, or two or more together, also may find a useful application in other types of constructions differing from the types described above. For example, the pellets could be adhered on both opposite surfaces of the sponge, that is, on the opposite exterior surfaces of the sponge, or on material layers secured to opposite surfaces of the sponge, or a combination thereof.

While the invention has been illustrated and described as embodied in scrubbing sponges and a method of making the same with indicia, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalents of the following claims.

What is claimed as new and desired to be protected by Letters Patent is set forth in the appended claims.

I claim:

1. An indicia-bearing cleaning device, comprising:
a) a sponge element having a generally planar outer surface;
b) indicia located at the outer surface of the sponge element;
c) a light-transmissive adhesive laid in a pattern on the outer surface of the sponge element; and
d) a plurality of discrete pellets of light-transmissive synthetic plastic material and having lower surfaces contacting the adhesive and adhered to the outer surface of the sponge element in the pattern, and upper surfaces for contacting a surface to be cleaned, the indicia being visible through the adhesive and the pellets.

2. The device according to claim 1, wherein the adhesive is constituted of a curable polyvinylchloride plastisol; and wherein the pellets are constituted of polyvinylchloride.

3. The device according to claim 1, and further comprising a material layer adhered to the outer surface of the sponge element, and wherein the indicia is printed on the material layer.

4. The device according to claim 1, wherein the pellets are of different spherical sizes.

5. The device according to claim 1, wherein the pellets are of different ovoidal sizes.

6. The device according to claim 1, wherein the pellets have a dimension in a range from 30 to 80 mils.

7. The device according to claim 1, wherein the pellets are arranged in clusters.

8. The device according to claim 7, wherein each cluster comprises a plurality of the pellets.

9. The device according to claim 8, wherein each cluster includes from three to ten pellets in number.

10. The device according to claim 7, wherein the clusters are spaced apart from one another.

11. The device according to claim 1, wherein the indicia identifies a product to be promoted.

12. The device according to claim 1, wherein the indicia identifies an organization to be promoted.

13. The device according to claim 1, wherein the indicia is a permanent marking non-soluble in water.

14. A method of making an indicia-bearing cleaning device, comprising the steps of:
a) providing indicia at a generally planar, outer surface of a sponge element;
b) applying a light-transmissive adhesive in a pattern on the outer surface of the sponge element; and
c) adhering a plurality of discrete, shaped pellets of light-transmissive synthetic plastic material to the outer surface of the sponge element by contacting lower surfaces of the pellets on the adhesive, and by exposing upper surfaces of the pellets above the outer surface of the sponge element for contacting a surface to be cleaned, the indicia being visible through the adhesive and the pellets.

15. The method according to claim 14, wherein the applying step is performed by laying a curable polyvinylchloride plastisol on the outer surface of the sponge element in the pattern.

16. The method according to claim 14, wherein the providing step is performed by printing the indicia on a material layer, and adhering the material layer to the outer surface of the sponge element.

17. The method according to claim 14, wherein the adhering step is performed by arranging the pellets in clusters.

18. The method according to claim 14, wherein the providing step includes printing the indicia with a permanent marking which is non-soluble in water.
